(19) United States
(12) Patent Application Publication
(10) Pub. No.: US 2015/0343799 A1
(43) Pub. Date: Dec. 3, 2015

(54) PRINTER APPARATUS

(71) Applicant: TOSHIBA TEC KABUSHIKI KAISHA, Tokyo (JP)

(72) Inventors: Tsuyoshi Sanada, Susono-shi (JP); Yuji Kawamorita, Mishima-shi (JP)

(73) Assignee: TOSHIBA TEC KABUSHIKI KAISHA, Tokyo (JP)

(21) Appl. No.: 14/291,366

(22) Filed: May 30, 2014

(51) Int. Cl. B41J 11/00; B41J 11/66; B41J 13/00

(52) U.S. Cl. CPC B41J 11/0075; B41J 13/0009; B41J 11/663

(57) ABSTRACT

A printer apparatus provided with a paper conveyance path along which the roll paper rolled on a roll core having a predetermined diameter is conveyed; a printing section configured to perform a specified printing operation on the roll paper; a cutter configured to cut off the roll paper on which the specified printing operation is performed; a first sensor configured to detect a given diameter of the roll paper greater than the diameter of the roll core; a second sensor configured to detect a given diameter of the roll paper smaller than the diameter detected by the first sensor but greater than the diameter of the roll core; a paper length calculation section configured to calculate the length of the roll paper used from the detection of the first sensor to the detection of the second sensor; a paper thickness calculation section configured to calculate the thickness of the roll paper; and a residual paper amount calculation section configured to calculate the length of the residual roll paper available from the detection of the second sensor to the exhaustion of the roll paper rolled on the roll core.

### FIELD

Embodiments described herein relate to a printer apparatus which prints on rolled paper and then issues the printed paper.

### BACKGROUND

In a printer apparatus used as an apparatus for issuing, for example, a receipt, after given items are printed on ruler-shaped paper drawn from paper rolled on a roll core in a roll shape, the printed paper is cut into a given length and then discharged.

A paper exhaustion sensor for detecting the exhaustion of paper is arranged on the printer apparatus to notify the user of the exhaustion of paper when the exhaustion of paper is detected.

After paper is totally used and before new paper is supplemented, there is a non-operation time in the printer. Thus, a method is also known which is called near-end detection method for mastering the amount of residual paper and giving a notice before paper is used up.

In the method for mastering the amount of residual paper and giving a notice before paper is used up, although the non-operation time is eliminated, paper needs to be replaced by new roll paper at the time point the reduction in the amount of residual paper is detected, the replaced roll paper, although printable paper is remained before completely being used up on a roll core, is disposed, which leads to the waste of paper.

### BRIEF DESCRIPTION OF THE DRAWINGS

FIG. 1 is a diagram illustrating the main components of the printer apparatus according to an embodiment;

FIG. 2 is a control block diagram of the printer apparatus according to the embodiment;

FIG. 3 is a flowchart illustrating the running of the printer apparatus according to the embodiment;

FIG. 4 is an illustration diagram illustrating a roll paper diameter detection position and the size of a roll core according to the embodiment;

FIG. 5 is an illustration diagram illustrating a signal acquisition method for a paper length calculation according to the embodiment;

FIG. 6 is a diagram illustrating the main part of a rotary slit disk according to the embodiment for acquiring a signal to perform a paper length calculation;

FIG. 7 shows an example of other configuration positions of a first and a second sensor according to the embodiment;

FIG. 8 shows an example of other configuration positions of a first and a second sensor according to the embodiment;

FIG. 9 is a flowchart illustrating the running of the printer apparatus according to embodiment 2; and

FIG. 10 is a flowchart illustrating the running of the printer apparatus according to embodiment 3.

### DETAILED DESCRIPTION

A printer apparatus comprises: a paper conveyance path along which the roll paper rolled on a roll core having a predetermined diameter size is conveyed; a printing section configured to perform a specified printing operation on the roll paper; a cutter configured to cut off the roll paper on which the specified printing operation is performed; a first sensor configured to detect a given diameter of the roll paper which is greater than the diameter of the roll core; a second sensor configured to detect a given diameter of the roll paper which is smaller than the diameter detected by the first sensor but greater than the diameter of the roll core; a paper length calculation section configured to calculate the length of the roll paper used from the detection of the first sensor to the detection of the second sensor; a paper thickness calculation section configured to calculate the thickness of the roll paper; and a residual paper amount calculation section configured to calculate the length of the residual roll paper available from the detection of the second sensor to the exhaustion of the roll paper rolled on the roll core.

### Embodiment 1

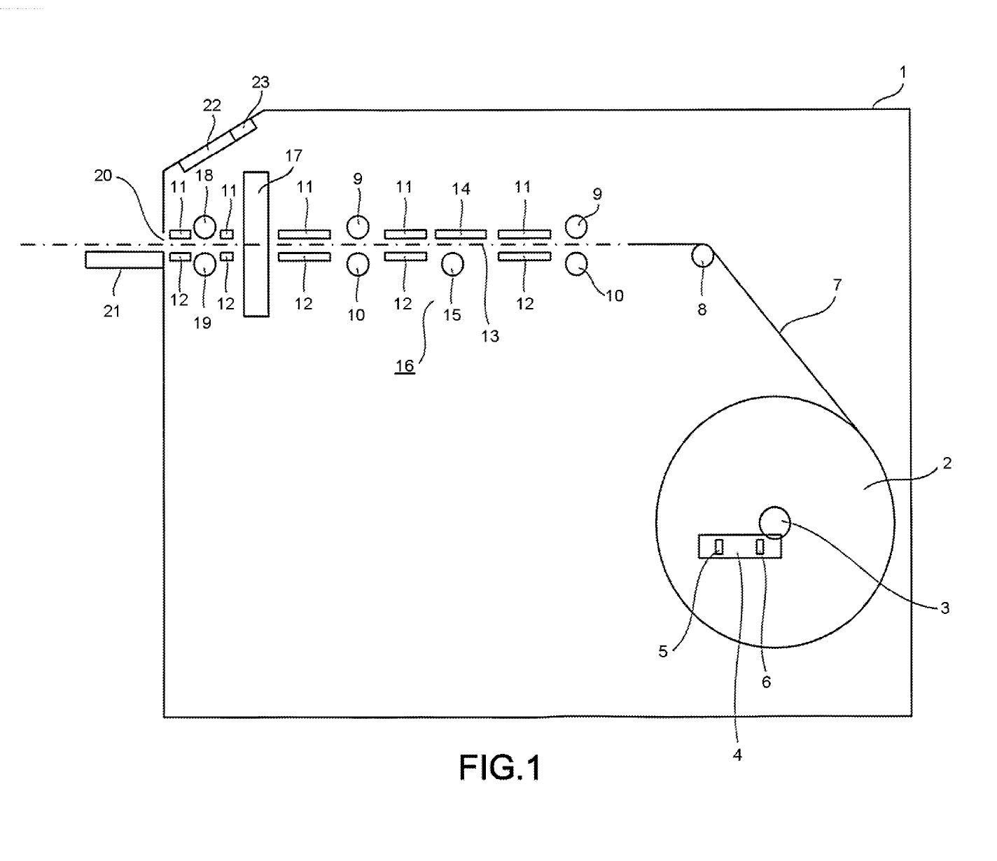

The printer apparatus according to embodiment 1 is described below in detail with reference to FIG. 1-FIG. 6.

FIG. 1 is a diagram illustrating the main components of a printer apparatus 1 according to embodiment 1. Further, in the printer apparatus, as paper is conveyed from the right side to the left side of FIG. 1, the right side of FIG. 1 is hereinafter referred to as an upstream side and the left side of FIG. 1 as a downstream side.

In FIG. 1, the reference sign ‘2’ represents the roll paper rolled on a roll core 3 which is supported on the printer apparatus 1 in a freely rotatable manner.

The roll paper 2 has a thermosensitive layer which generates a color only when a paper surface A7, which is one of the sides of the roll paper 2, is heated. Further, a sensor holder 4 is mounted on the frame (not shown) of the printer apparatus 1, and a first sensor 5 and a second sensor 6 for detecting end parts of the roll paper 2 are arranged on the sensor holder 4.

An idler roller 8 is supported at the downstream side of the roll paper 2 in a freely rotatable manner.

Further, an upper conveyance guide 11 and a lower conveyance guide 12 are arranged from the idler roller 8 of the printer apparatus 1 to the downstream side of the printer apparatus 1 in an extending manner to convey the paper 2 by taking the space between the upper conveyance guide 11 and the lower conveyance guide 12 as a paper conveyance path 13.

Further, conveyance rollers 9 which can be rotated by a motor (not shown) are arranged face to conveyance idler rollers 10 across the paper conveyance path 13 at the downstream side of the idler roller 8, and the roll paper 2 clamped by the conveyance roller 9 and the conveyance idler roller 10 is conveyed to the downstream side direction through the cooperation of the conveyance roller 9 and the conveyance idler roller 10. The conveyance rollers 9 and the conveyance idler rollers 10, which are used in pair, are arranged along the paper conveyance path 13 in a plurality of groups.

A thermal print head 14 and a platen roller 15 which can be rotated by a motor (not shown) with respect to the thermal print head 14 across the paper conveyance path 13 are arranged at the downstream side of the idler roller 8, and the thermal print head 14 and the platen roller 15 constitute a printing section 16 by which the paper surface A7 of the roll paper 2 is printed.

A cutter 17 is arranged at the downstream side of the printing section 16. The cutter 17 has a movable blade (not shown) and a fixed blade (not shown) towards which the movable blade slides under the drive of a cutter motor (not shown) to cut off paper. Further, in the embodiment, the cutter is described as a slide cutter the movable blade of which slides towards the fixed blade thereof to cut off paper, however, the present invention is not limited to this, the cutter may also be the so-called rotary cutter the movable blade of which rotationally contacts paper with respect to the fixed blade thereof to cut off paper.

A discharge roller 18 and a discharge idler roller 19 are arranged face to face at the downstream side of the cutter 17 across the paper conveyance path 13, the cut roll paper 2 is conveyed to the downstream side through the cooperation of the discharge idler 18 and the discharge idler roller 19 and then discharged to the outside of the printer apparatus 1 through a paper outlet 20 arranged on the printer apparatus 1. A discharge table 21 is arranged below the paper outlet 20, and the roll paper 2 discharged to the outside of the printer apparatus 1 through the paper outlet 20 is held on the discharge table 21 to be prevented from falling onto the ground.

A display section 22 is arranged above the paper outlet 20 of the printer apparatus 1 to display various states of the printer apparatus 1, including an error state. Further, a setting section 23 is arranged nearby the display section 22. The setting section 23 is provided with buttons with which various setting can be made.

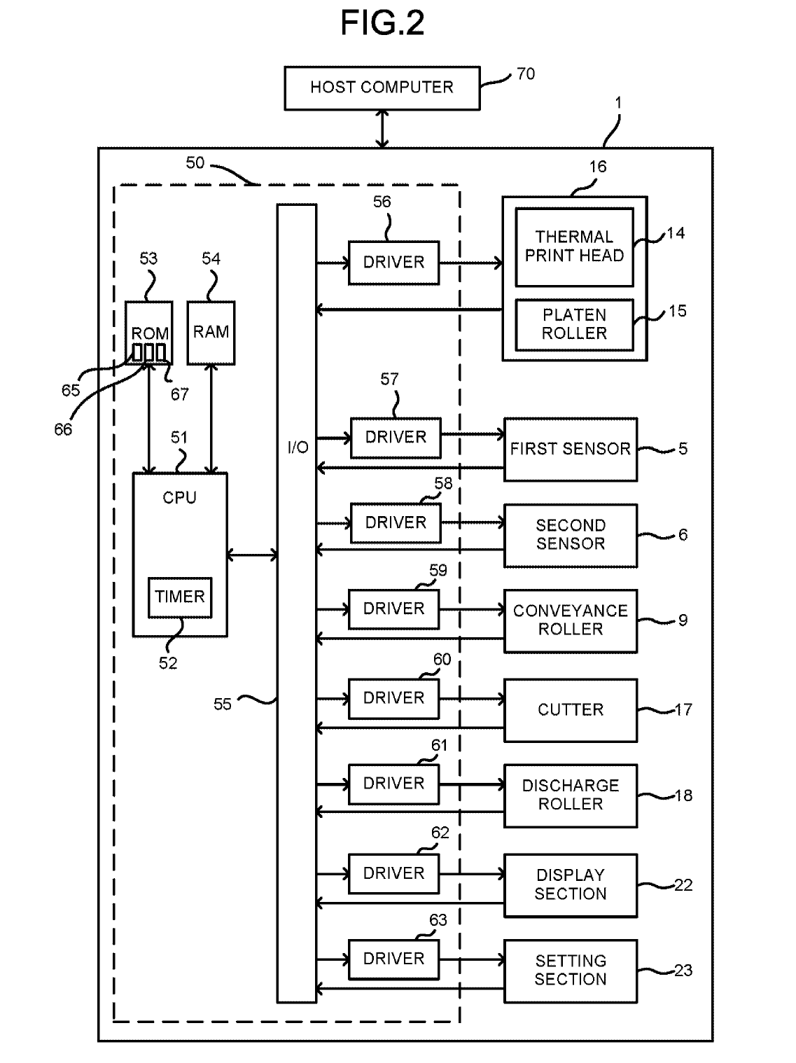

FIG. 2 is a block diagram illustrating the structure of the control loop of the printer apparatus 1 according to embodiment 1. The control section 50 controls the conveyance of paper, the roll paper outer diameter detection by the sensor, a printing operation, the paper cutting, the discharging of paper, the condition display of the printer apparatus and the setting of the printer apparatus and the like.

The control section 50 consists of, for example, a microcomputer which links with a host computer 70 and carries out various controls.

The Central Processing Unit (CPU) 51 of the control section 50 carries out various controls and operations according to programs, including a paper conveyance control, a printing control, a paper cutting control, a paper discharging control, a roll diameter detection control, a condition display control, a paper length calculation, a paper thickness calculation and a residual paper amount calculation.

Further, the CPU 51 includes a timer 52 serving as a time setting and controlling unit.

An ROM 53 and an RAM 54 are arranged in the control section 50 as primary memory units for storing the control programs executed by the CPU 51 or the data generated in an operation process.

The ROM 53 is a read-only memory in which control programs or tables are stored, and the RAM 54 is a random access memory for storing the data generated in an operation process and the like.

Further, a paper length calculation section 65 for calculating the length of the roll paper 2, a paper thickness calculation section 66 for calculating the thickness of the roll paper 2 and a residual paper amount calculation section 67 for calculating the residual amount of the roll paper 2, which will be described later, are arranged in the ROM 53.

An input/output (I/O) unit 55 is arranged in the control section 50 to acquire various input data from the host computer 70 and export the control output of the control section 50 to the host computer 70. The I/O 55 connects the CPU 51, the ROM 53 and the RAM 54 via a bus line.

As units for exporting control output, a first, second, third, fourth, fifth, sixth, seventh and eighth drivers 56, 57, 58, 59, 60, 61, 62 and 63 are connected with the I/O 55.

The first driver 56 supplies a necessary drive output for the printing section 16. The second driver 57 supplies a necessary drive output for the first sensor 5. The third driver 58 supplies a necessary drive output for the second sensor 6. The fourth driver 59 supplies a necessary drive output for the conveyance roller 9. The fifth driver 60 supplies a necessary drive output for the cutter 17. The sixth driver 61 supplies a necessary drive output for the discharge roller 18. The seventh driver 62 supplies a necessary drive output for the display section 22. The eighth driver 63 supplies a necessary drive output for the setting section 23.

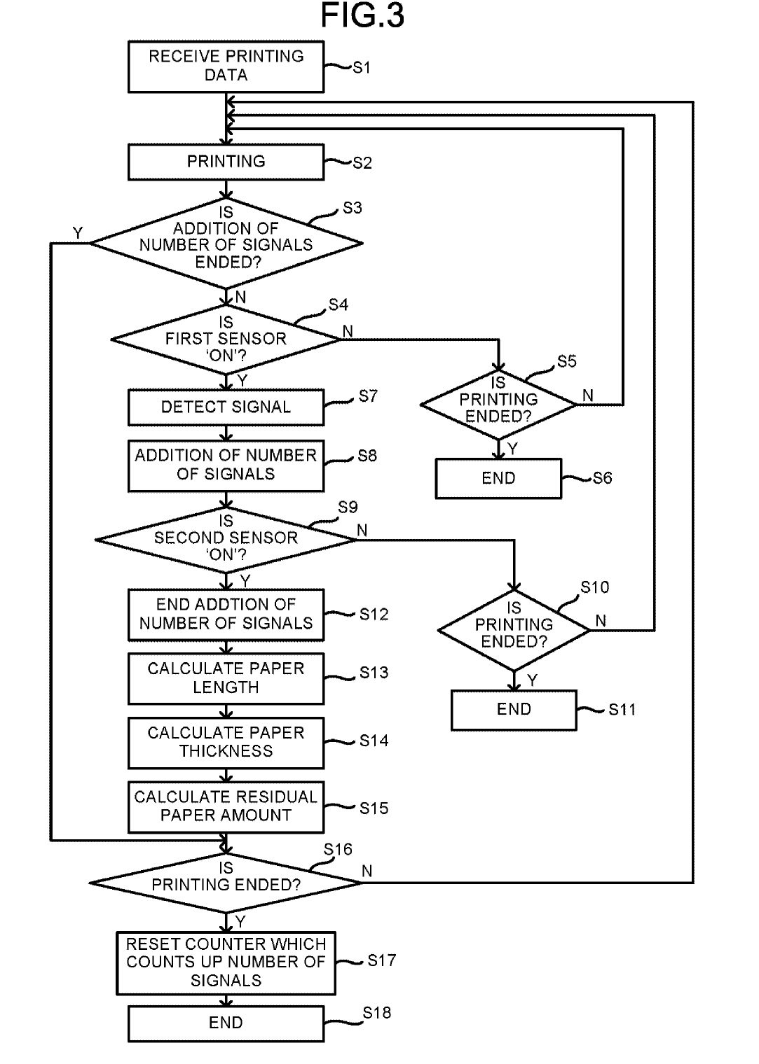

Next, operations of the printer apparatus 1 are described with reference to FIG. 3.

The operator opens the cover (not shown) of the printer apparatus 1 to load the roll paper 2 rolled on the roll core 3 into the printer apparatus 1. Next, the operator pulls out the roll paper 2 and sets the front end of the roll paper 2 passing the idler roller 8 to be clamped by the conveyance roller 9 and conveyance idler roller 10 at the furthest upstream side. Further, at the time point the printer apparatus 1 starts to be used, a counter for counting the number of the under-mentioned light receiving signals generated by the under-mentioned light-receiving element 32 is reset while a record ‘the addition of the number of the light receiving signals is not ended’ is recorded.

If printing data is received from the host computer 70 in this state (S1), the roll paper 2 is conveyed towards the downstream side in the paper conveyance path 13 through the cooperation of the conveyance roller 9 and the conveyance idler roller 10.

The conveyed roll paper 2 sequentially enters the printing section 16. A printing operation is carried out on the paper surface A7 of the roll paper 2 entering the printing section 16 through the cooperation of the thermal print head 14 and the platen roller 15 (S2).

Next, the control section 50 confirms whether or not the addition of the number of the signals is ended (S3). As stated above, it is recorded that the addition of the number of the signals is not ended at the time point the printer apparatus 1 starts to be used. Here, as the addition of the number of the signals is not ended at this moment (No in S3), the control section 50 sequentially confirms whether or not the first sensor is ‘ON’ (S4).

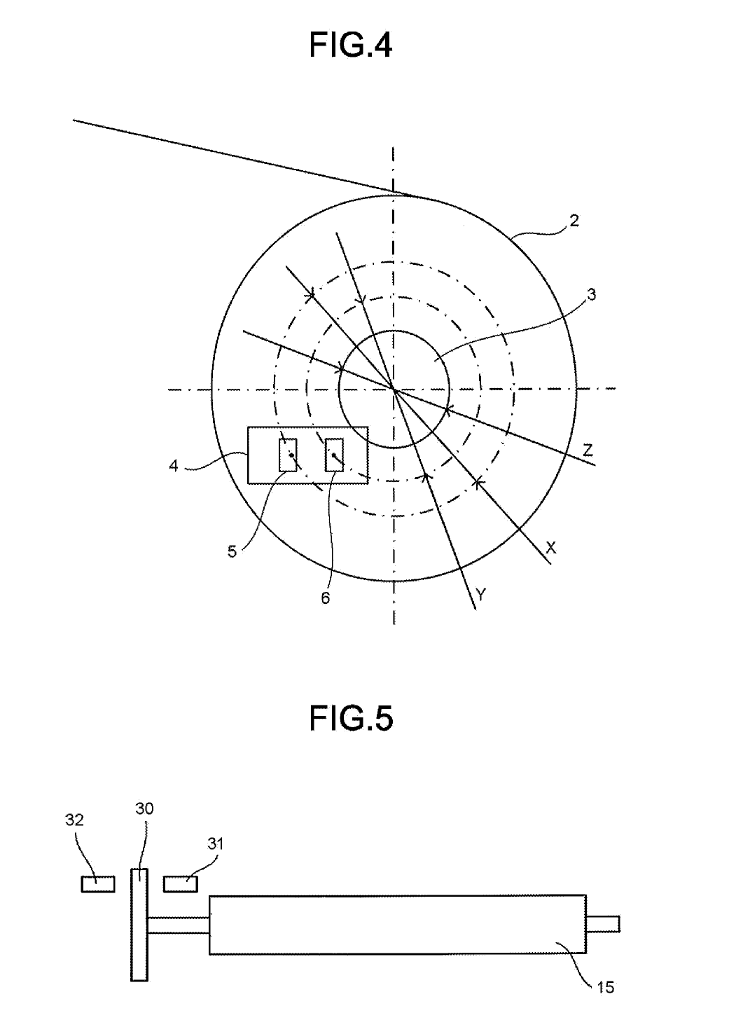

In FIG. 4, the position relationship among the roll paper 2, the roll core 3, the sensor holder 4, the first sensor 5 and the second sensor 6 is described in detail.

The roll paper 2 rolled on the roll core 3 is supported on the printer apparatus 1 in a freely rotatable manner. Further, the sensor holder 4 is arranged on the frame (not shown) of the printer apparatus 1, and the first sensor 5 and the second sensor 6 are arranged on the sensor holder 4.

The first sensor 5 and the second sensor 6 are provided with a light emitting section (not shown) and a light receiving section (not shown), respectively, and are opposite to each other in the width direction of the roll paper 2.

The first sensor 5 and the second sensor 6 emit detection light (not shown) from the light emitting section continuously to the light receiving section. The roll paper 2, if located between the light emitting section and the light receiving section, blocks the incidence of the detection light to the light receiving section. However, if the roll paper 2 is used and then the diameter of the left roll paper 2 is too small to block the detection light, the light receiving section receives the detection light and sends a detection signal. The first sensor 5 is arranged at a position where a detection signal is given when the diameter of the paper roll reaches X, and the second sensor 6 is arranged at a position where a detection signal is given when the diameter of the paper roll reaches Y. That is, the detection signal is received once when the diameter of the paper roll reaches X as the roll paper 2 is used and once again when the diameter of the paper roll reaches Y as the roll paper 2 is continuously used.

In the case of a printing process, the roll paper 2 is conveyed towards the downstream side by the platen roller 15 while the paper surface A7 of the roll paper 2 is printed by the thermal print head 14. The residual amount of the roll paper 2 is reduced when the roll paper 2 is conveyed to the downstream side. The reduction in the residual amount of the roll paper is embodied in the reduction of the diameter of the roll paper 2 as the roll paper 2 is rolled into a roll.

The control section 50 confirms whether or not the first sensor 5 is ON first (S4). The first sensor 5 is arranged at a position where a detection signal is issued when the diameter of the paper roll is reached X, at this time point, as the diameter of the paper roll does not reach X (No in S4), next, the control section 50 confirms whether or not the printing is ended (S5). The end of the printing refers to the completion of the printing of all the printing data sent from the host computer 70, and the printing is continued if not all the printing data is printed (No in S5). Whether or not the printing is ended is confirmed (S5), if the printing is ended (Yes in S5), at the time point the cutting position of the roll paper 2 conveyed later coincides with the cutting position of the cutter 17, the movable blade (not shown) slides towards the fixed blade (not shown) to cut off the roll paper 2, then, the cut roll paper 2 is discharged to the outside of the printer apparatus 1 from the paper outlet 20 through the cooperation of the discharge roller 18 and the discharge idler roller 19 and then held on the discharge table 21, and then the printing in the printer apparatus 1 is ended (S6).

Next, the first sensor 5 is turned ON if new printing data is received from the host computer 70 (S1), that is, the printing, cutting and discharging of the roll paper 2 are repeatedly performed until the diameter of the roll paper 2 reaches X.

During a printing process, the amount of the roll paper 2 is reduced, and the first sensor 5 is turned ON at the time point the diameter of the paper roll reaches X (Yes in S4). When the first sensor 5 is turned ON (Yes in S4), the control section 50 detects the signal of the under-mentioned light receiving element 32 (S7).

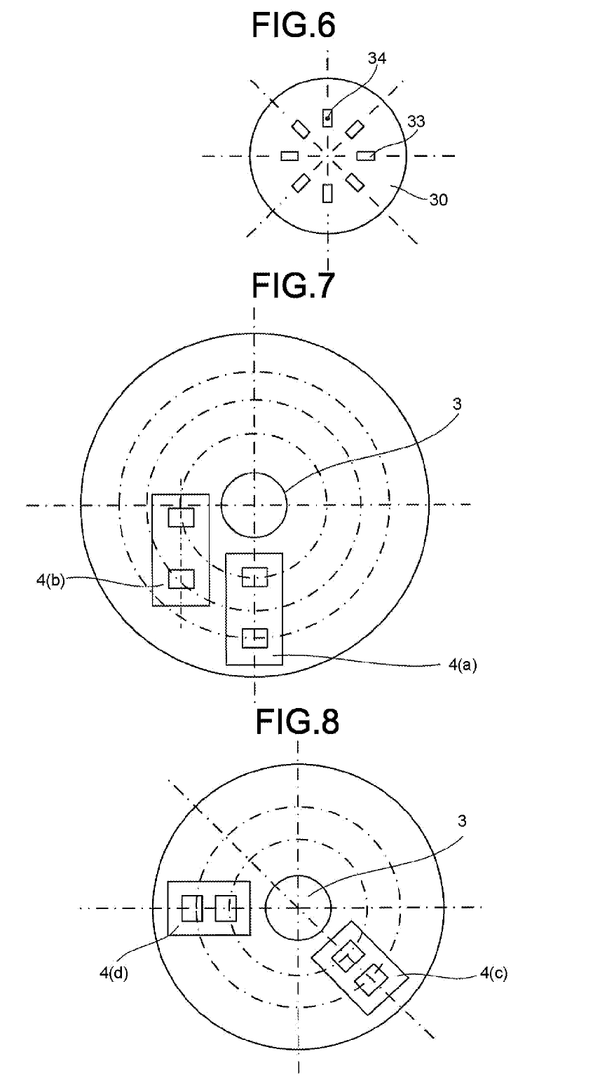

The signal detection on the light receiving element 32 is described with reference to FIG. 5 and FIG. 6.

A rotary slit disk 30 is arranged on the shaft of the platen roller 15. Further, the light emitting element 31 and the light receiving element 32 are arranged opposite to each other with the rotary slit disk 30 clamped therebetween in the thickness direction of the rotary slit disk 30.

Eight slits 33 are arranged on the rotary slit disk 30 at the same intervals, as shown in the example shown in FIG. 6. Further, the detection light (not shown) emitted from the light emitting element 31 enters the light receiving element 32, and the position 34 of the detection light is at a position through which the slits 33 are passed.

The light emitting element 31 continuously emits detection light towards the light receiving element 32, however, as the rotary slit disk 30 rotates with the rotation of the platen roller 15, the detection light passing through the slits 33 alternatively enters or does not enter the light receiving element 32. That is, in the case where there are eight slits on the rotary slit disk 30, the light receiving element 32 issues a detection signal for eight times as the platen roller 15 rotates a circle.

When a signal is detected once from the light receiving element 32 (S7), the control section 50 adds 1 to the counter arranged in the RAM 54 to count up the number of the light receiving signals (S8). As stated above, as the counter for counting up the number of the light receiving signals generated by the light receiving element 32 is reset at the time point the printer apparatus 1 starts to be used, the value of the counter for counting up the number of the light receiving signals is successively added thereafter. In addition, the number of the light receiving signals counted is kept but not erased even if the printer apparatus 1 is powered off.

After adding the light receiving signals to the counter for counting up the number of the light receiving signals (S8), the control section 50 confirms whether or not the second sensor 6 is ‘ON’ (S9). The second sensor 6 is located at a position where a detection signal is given when the diameter of the paper roll reaches Y, at this moment, as the diameter of the paper roll does not reach Y (No in S9), next, the control section 50 confirms whether or not the printing is ended (S10). Here, the end of the printing refers to the completion of the printing of all the printing data sent from the host computer 70, as stated above, and the printing is continued if not all the printing data is printed (No in S10). Whether or not the printing is ended is confirmed (S10), if the printing is ended (Yes in S10), the roll paper 2 is cut off and discharged, as stated above, and then the printing in the printer apparatus 1 is ended (S11).

Next, the second sensor 6 is turned ON if new printing data is received from the host computer 70 (S1), that is, the roll paper 2 is repeatedly printed, cut and discharged until the diameter of the roll paper reaches X, and the counter arranged in the RAM 54 for counting up the number of the light receiving signals adds the number of the light receiving signals.

During a printing process, the amount of the roll paper 2 is reduced, and the second sensor 6 is turned ON at the time point the diameter of the paper roll reaches Y (S9). When the second sensor 6 is turned ON (Yes in S9), the control section 50 ends the addition of the number of the light receiving signals by the counter arranged in the RAM 54 for counting up the number of the light receiving signals (S12), and a record ‘the addition of the number of signals is ended’ is recorded in the RAM 54.

Next, the paper length calculation section 65 calculates the length L of the roll paper 2 used from the moment the first sensor 5 is turned ON to the moment the second sensor 6 is turned ON, that is, from the moment the diameter of the paper roll reaches X to the moment the diameter of the paper roll reaches Y (S13). The method for calculating the length L of the roll paper 2 is described below.

The outer peripheral length of the platen roller 15 provided with the rotary slit disk 30 is known in advance, and the roll paper 2 is conveyed to the downstream side by the platen roller 15. That is, in the case where the rotary slit disk 30 is provided with eight slits 33, the detection signal of the light receiving element 32 is issued once every time the roll paper is conveyed by just ⅛ of the outer peripheral length of the platen roller. Thus, the length L of the roll paper 2 used from the time point the diameter of the paper roll reaches X to the time point the diameter of the paper roll reaches Y can be calculated by multiplying the number of the light receiving signals recorded in the counter arranged in the RAM 54 for counting up the number of the light receiving signals by ⅛ of the outer peripheral length of the platen roller.

In addition, although the length L of the roll paper 2 used from the time point the diameter of the paper roll reaches X to the time point the diameter of the paper roll reaches Y is calculated according to the number of the slits detected on the rotary slit disk 30 and the outer peripheral length of the platen roller 15 in this embodiment, the present invention is not necessarily limited to this. For example, if 30 pieces of A4 paper are output from the time point the diameter of the paper roll reaches X to the time point the diameter of the paper roll reaches Y, by multiplying the length (297 mm) of the A4 size paper by 30, the length L of the output paper can be calculated to be 8910 mm.

Next, the paper thickness calculation section 66 calculates the paper thickness t of the currently used roll paper 2 (S14). The method for calculating the paper thickness t is described below.

The diameter X and the diameter Y are determined in advance. Thus, the paper thickness calculation section 66 calculates the paper thickness t of the currently used roll paper 2 using the following formula: ((X/2)̂2−(Y/2)̂2)*π/L.

For example, in the case where the diameter X is 56 mm, the diameter Y is 50 mm and the length of the roll paper used from the detection of the first sensor 5 to the detection of the second sensor is calculated to be 8717, the paper thickness t is calculated by the following formula: ((56/2)̂2−(50/2)̂ 2)*π/8717=0.0573.

Next, the residual paper amount calculation section 67 calculates the amount of the residual paper used from the time point the diameter of the paper roll reaches Y to the time point the roll paper 2 is used up (S15). The method for calculating the amount R of the residual paper is described below.

The diameter Y is determined in advance, and the diameter Z of the roll core 3 can be mastered. Thus, the residual paper amount calculation section 67 calculates the amount R of the residual roll paper 2 available from the time point the diameter of the paper roll reaches Y to the time point the roll paper 2 is used up using the following formula: ((Y/2)̂2−(Z/2) ̂2)*π/t.

For example, if the diameter Z of the roll core is 25 mm, the amount R of the residual paper is calculated by the following formula: ((50/2)̂2−(25/2)̂2)*π/0.0573=25687 mm.

Next, the control section 50 determines whether or not the printing is ended (S16). Here, the end of the printing refers to the completion of the printing of all the printing data sent from the host computer 70, as stated above. The printing is continued if not all the printing data is printed (No in S16). Here, a printing operation is carried out (S2), then the control section 50 confirms again whether or not the addition of the number of signals is ended (S3). As a record ‘the addition of the number of signals is ended’ is already recorded in the RAM 54 in this state (Yes in S3), whether or not the printing is ended is confirmed again (S16). The aforementioned operations are continuously performed until it is determined that the printing is ended (Yes in S16).

If the printing is ended (Yes in S16), the control section 50 resets the counter which counts up the number of the signals (S17) for the reason of the loading of new roll paper 2 and a new paper length calculation.

Then, the printer apparatus 1 ends the printing with the printing data sent from the host computer 70 (S18).

As stated above, in embodiment 1, the residual paper amount calculation section 67 of the printer apparatus 1 is capable of calculating and mastering the amount R of the residual paper available from the time point the diameter of the paper roll reaches Y to the time point the roll paper 2 is used up, thus preventing the roll paper 2 from being disposed after the conventional near-end detection. For example, if the amount of the printing data sent from the host computer 70 is fixed, the length of a piece of roll paper 2 is also fixed. Thus, it can be mastered how many pieces of paper can be printed from the time point the diameter of the paper roll reaches Y to the time point the roll paper 2 is used up, which reduces the waste of the roll paper 2 and makes it easy to master the time point paper is used up.

Further, the aforementioned configuration positions of the first sensor 5 and the second sensor 6 are adopted in embodiment 1, however, in the case where the detection diameter X in the first sensor 5 is different from the detection diameter Y in the second sensor 6, the first sensor 5 and the second sensor 6 may be configured at other positions. For example, as shown in FIG. 7, two sensors may be configured on the center line of the roll core 3, as shown by the sensor holder 4 (a), or two sensors may be configured at positions deviated from the plumb line of the roll core 3, as shown by the sensor holder 4 (b).

Further, two sensors may also be configured at positions which form a certain angle with the plumb line of the roll core 3 or at positions vertical to the plumb line of the roll core 3, as shown by 4(c) or 4(d) shown in FIG. 8.

### Second Embodiment

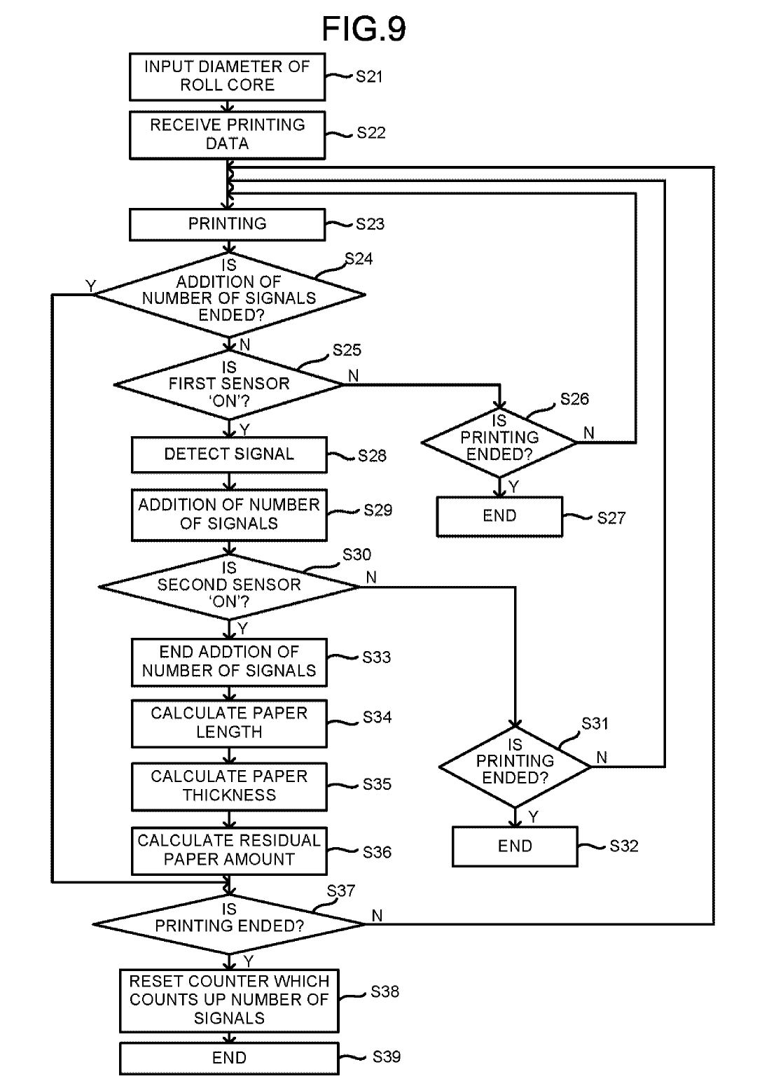

The printer apparatus according to embodiment 2 is described below in detail with reference to FIG. 9. The same parts of embodiments 1 and 2 are not repeatedly described in detail here.

In embodiment 2, the size of the roll core 3 is acquired from outside and the residual paper amount R is calculated based on the size of the roll core 3.

Although roll paper 2 is used in the printer apparatus 1, sometimes other paper recommended for use but different from roll paper may be prepared and loaded by the user. Further, there are users who set the size of the roll core 3 to be small to roll more paper to minimize the possibility of paper exhaustion. In this case, it is necessary to change the diameter Z of the roll core 3 stored in the printer apparatus 1 in advance.

In embodiment 2, in the use of the printer apparatus 1, the residual paper amount R is calculated using the size of the roll core 3 input by the user.

The user of the printer apparatus 1 initially inputs the diameter size of a roll core 3 for current use using an input button (not shown) of the setting section 23 (S21). Apart from this, as a diameter size input method, the model numbers of a plurality of use candidates for the roll paper 2 may be displayed on the display section 22 for the user to select the roll paper 2 to be used currently. In this case, a using roll paper specification table (not shown) is set in the ROM 53, when a roll paper 2 is selected for use, the diameter size of the roll core 3 which is recorded in association with the selected roll paper 2 is read from the table of the selected roll paper 2. In this way, the printer apparatus 1 can master the diameter size of the roll core 3. Thereafter, like in embodiment 1, the paper length L is calculated according to the number of the signals issued from the moment the first sensor 5 is turned ON to the moment the second sensor 6 is turned ON (S34), afterwards, the paper thickness t is calculated (S35), and then the residual paper amount R is calculated using the data on the input diameter size of the roll core 3 (S36).

In this way, in embodiment 2, the residual paper amount can be calculated even if the size of the roll core 3 for the roll paper 2 to be used is not a recommended one.

### Embodiment 3

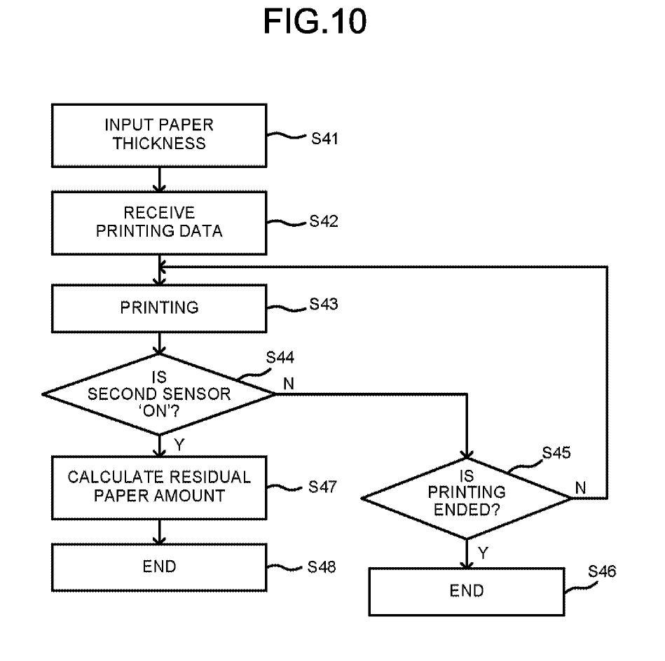

The printer apparatus according to embodiment 3 is described below in detail with reference to FIG. 10. The same parts of embodiments 1, 2 and 3 are not repeatedly described in detail here.

In embodiment 3, the paper thickness t of the roll paper 2 to be used is acquired from outside, and the residual paper amount R is calculated based on the paper thickness t of the roll paper 2.

In embodiment 1, the length L of the paper used from the moment the first sensor 5 is turned ON to the moment the second sensor 6 is turned ON is calculated, the paper thickness t is sequentially calculated based on the paper length L, and then the residual paper amount R is calculated. However, there is a kind of paper on the market which is increased accordingly in the length of each piece of paper as the paper thickness t is reduced. In this case, a paper thickness t is clearly recorded in advance.

In the use of this kind of paper, as long as a paper thickness t is clear in advance, then the length L of the paper used from the moment the first sensor 5 is turned ON to the moment the second sensor 6 is turned ON is calculated, and the residual paper amount R can be calculated at the time point the second sensor 6 is turned ON without calculating paper thickness based on the paper length L.

The user of the printer apparatus 1 initially inputs the paper thickness t of the roll paper 2 to be used currently using an input button (not shown) of the setting section 23 (S41). Apart from this, as a paper thickness t input method, the model numbers of a plurality of use candidates for the roll paper 2 may be displayed on the display section 22 for the user to select the roll paper 2 to be used currently. In this case, a using roll paper specification table (not shown) is set in the ROM 53, when a roll paper 2 is selected for use, the information of the paper thickness t of the roll paper 2 which is recorded in association with the selected roll paper 2 is read from the table of the selected roll paper 2. In this way, the printer apparatus 1 can master the paper thickness t of the roll paper 2.

Further, if the paper thickness t of the roll paper 2 is mastered in advance, the length L of the paper used is calculated according to the number of the signals sent from the time point the first sensor 1 is turned ON to the time point the second sensor 6 is turned ON and then there is no necessary to calculate the paper thickness t. Thus, the configuration of the first sensor 5 in the printer apparatus 1 is not needed, the configuration of merely the second sensor 6 is sufficient.

If it is detected that the second sensor 6 is turned ON (Yes in S44), the residual paper amount detection section 67 calculates the residual paper amount R using the input paper thickness t, the diameter of X and Y (S47). Further, in the use of the printer apparatus 1 provided with the first sensor 5 and the second sensor 6, like in embodiments 1 and 2, the printer apparatus 1 can be directly used without activating the first sensor 5 and the light receiving element 32 and the like. Additionally, in embodiment 3, the diameter size of the roll core 3 may be input using the setting section 23, like in embodiment 2.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A printer apparatus, comprising:
a paper conveyance path along which the roll paper rolled on a roll core having a predetermined diameter is conveyed;
a printing section configured to perform a specified printing operation on the roll paper;
a cutter configured to cut off the roll paper on which the specified printing operation is performed;
a first sensor configured to detect a given diameter of the roll paper which is greater than the diameter of the roll core;
a second sensor configured to detect a given diameter of the roll paper which is smaller than the diameter detected by the first sensor but greater than the diameter of the roll core;
a paper length calculation section configured to calculate the length of the roll paper used from the detection of the first sensor to the detection of the second sensor;
a paper thickness calculation section configured to calculate the thickness of the roll paper; and
a residual paper amount calculation section configured to calculate the length of the residual roll paper available from the detection of the second sensor to the exhaustion of the roll paper rolled on the roll core.

2. A printer apparatus, comprising:
a paper conveyance path along which the roll paper rolled on a roll core is conveyed;
a printing section configured to perform a specified printing operation on the roll paper;
a cutter configured to cut off the roll paper on which the specified printing operation is performed;
a first sensor configured to detect a given diameter of the roll paper which is greater than the diameter of the roll core;
a second sensor configured to detect a given diameter of the roll paper which is smaller than the diameter detected by the first sensor but greater than the diameter of the roll core;
an input section configured to input the diameter size of the roll core;
a paper length calculation section configured to calculate the length of the roll paper used from the detection of the first sensor to the detection of the second sensor;
a paper thickness calculation section configured to calculate the thickness of the roll paper; and
a residual paper amount calculation section configured to calculate the length of the residual roll paper available from the detection of the first sensor to the exhaustion of the roll paper on the roll core.

3. A printer apparatus, comprising:
a paper conveyance path along which the roll paper rolled on a roll core having a predetermined diameter is conveyed;
a printing section configured to perform a specified printing operation on the roll paper;
a cutter configured to cut off the roll paper on which the specified printing operation is performed;
a sensor configured to detect a given diameter of the roll paper which is greater than the diameter of the roll core;
an input section configured to input the thickness of the roll paper; and
a residual paper amount calculation section configured to calculate the length of the residual roll paper available from the detection of the sensor to the exhaustion of the roll paper rolled on the roll core.

4. A printer apparatus, comprising:
a paper conveyance path along which the paper rolled on a roll core is conveyed;
a printing section configured to perform a specified printing operation on the roll paper;
a cutter configured to cut off the roll paper on which the specified printing operation is performed;
a sensor configured to detect a given diameter of the roll paper which is greater than the diameter of the roll core;
an input section configured to input the thickness of the roll paper and the diameter size of the roll core; and
a residual paper amount calculation section configured to calculate the length of the residual roll paper used from the detection of the sensor to the exhaustion of the roll paper rolled on the roll core.
